(19) United States
(12) Patent Application Publication
(10) Pub. No.: US 2016/0306893 A1
(43) Pub. Date: Oct. 20, 2016

(54) URL PURIFICATION METHOD AND URL PURIFICATION APPARATUS

(71) Applicant: Beijing Qihoo Technology Company Limited, Beijing (CN)

(72) Inventors: Lei ZHOU, Beijing (CN); Yang GAO, Beijing (CN); Xin JIANG, Beijing (CN); Xingyuan NIU, Beijing (CN); Yingxue JIANG, Beijing (CN)

(21) Appl. No.: 15/100,951

(22) PCT Filed: Nov. 21, 2014
(86) PCT No.: PCT/CN2014/091924

§ 371 Date: Jun. 1, 2016

(30) Foreign Application Priority Data
Dec. 2, 2013 (CN) 201310632492.1

(51) Int. Cl. G06F 17/30

(52) U.S. Cl. CPC G06F 17/30887; G06F 17/30864

(57) ABSTRACT

Disclosed is a URL purification method including the steps of: matching an original URL with a domain name in a domain name set which is capable of being purified; locating a successfully-matched domain name to a corresponding URL template set; matching the original URL with a regular expression of a URL template in the URL template set; determining whether the template in which the regular expression is matched successfully includes a command word; if yes, processing the URL according to the command word, if not, returning to the original URL; and outputting a purified new URL. The disclosure further discloses a URL purification device. After a URL with many forms is purified, whether the URL has been crawled may be determined, and the URL is not crawled again if it has been crawled before, thereby significantly improving the capability of crawling valid web pages by a crawler, and saving various resources.

### CROSS-REFERENCE TO RELATED APPLICATIONS

The present disclosure is the national stage of International Application No. PCT/CN2014/091924 filed Nov. 21, 2014, which is based upon and claims priority to Chinese Patent Application No. CN201310632492.1, filed Dec. 2, 2013, the entire contents of which are incorporated herein by reference.

### FIELD OF TECHNOLOGY

The present disclosure relates to a URL purification method and a URL purification apparatus and, more particularly, to a method for purifying URLs in a website with a variety of URL forms.

### BACKGROUND

A URL (Uniform Resource Locator), the address of a resource on the Internet, is also known as a website. In the present disclosure, the “website” in Chinese is conceptually identical to the abbreviated “URL” in English. The URL consists of the following portions from left to right:

an Internet resource type (scheme), which indicates a tool operated by a WWW (World Wide Web) client program. For example, “http://” represents a WWW server, “ftp://” represents an FTP (File Transfer Protocol) server, “gopher://” represents a Gopher server, while “new:” represents a Newgroup;

a server address (host), which indicates a domain name of a server where a WWW page is;

a port (port), wherein a corresponding port number for the server should be provided to access some resources sometimes (not always); and

a path (path), which indicates a location of a certain resource on the server, with a format identical to that in a DOS (Disk Operating System), usually in such a structure as catalog/subcatalog/filename. The same as the port, the path is not always required.

A URL address is in such a format arrangement as scheme://host:port/path, and for example http://www.microsoft.com:80/products is a typical URL address.

Nowadays, as the means of website promotion increases, additional URL processing will be executed on a large number of websites in order to make statistics of traffic sources of current URLs. Some add additional information after a URL body, and some vary the URL form. These additional forms witness increased efficiency of a website, but are a nightmare for a search engine crawler for the reason that the crawler in the prior art does not actively differentiate such additional information in crawling, but crawls varied URLs respectively, however, the crawled content is an identical webpage. For the crawler, the storage space of a URL dispatching module, bandwidth and resource of a computer are wasted, which results in low practical service efficiency of the crawler.

### SUMMARY

In view of the problems above, it is needed to improve capacity of the search engine crawler to crawl valid webpages and increase practical service efficiency of the crawler, so as to save such resources as storage space, bandwidth, CPU (Central Processing Unit), internal storage and the like.

As a result, according to an aspect of the present disclosure, there is provided a uniform resource locator (URL) purification method comprising the steps of:

matching an original URL with a domain name in a domain name set which is capable of being purified;

locating a successfully-matched domain name to a corresponding URL template set;

matching the original URL with a regular expression of a URL template in the URL template set;

determining whether the template in which the regular expression is matched successfully includes a command word; if yes, processing the URL according to the command word, if not, returning to the original URL; and

outputting a purified new URL.

According to another aspect of the present disclosure, there is provided a computer program comprising computer readable code, when the computer readable code is executed on a computer, the URL purification method above is performed.

According to another aspect of the present disclosure, there is provided a computer readable medium which stores the computer program above.

According to still another aspect of the present disclosure, there is provided a uniform resource locator (URL) purification device including the modules of:

a domain name matching module, configured to match an original URL with a domain name in a domain name set which is capable of being purified;

a locating module, configured to locate a successfully-matched domain name to a corresponding URL template set;

a template matching module, configured to match the original URL with a regular expression of a URL template in the URL template set;

a command word processing module, configured to determine whether the template in which the regular expression is matched successfully includes a command word; if yes, processing the URL according to the command word, if not, returning to the original URL; and

an outputting module, configured to output a purified new URL.

It can be seen from a URL purification method according to embodiments of the present disclosure that, before the crawler crawls a webpage, preprocessing is required for URLs to be crawled, and URLs in various forms are converted into that which has the same form, which is also called URL purification or URL uniformization in the present disclosure. For a purified URL, a bloom filter can be employed to determine whether a webpage has been crawled; if the webpage has been crawled, secondary crawling is not necessary; and therefore the capacity of the crawler to crawl valid webpages can be improved obviously, and such resources as storage space, bandwidth, CPU, internal storage and the like can be saved.

The above description is an overview of the technical solution of the present disclosure. In order to understand the technical means of the present disclosure more clearly, enable the present disclosure implementable based on the specification, and make the above and other purposes, characteristics and advantages of the present disclosure clearer and easier to understand, embodiments of the present disclosure are described herein below.

### BRIEF DESCRIPTION OF THE DRAWINGS

Through reading the detailed description of the following preferred embodiments, various other advantages and benefits will become apparent to an ordinary person skilled in the art. Accompanying drawings are merely included for the purpose of illustrating the preferred embodiments and should not be considered as limiting of the disclosure. Further, throughout the drawings, same elements are indicated by same reference numbers. In the drawings:

FIG. 1 illustrates a flow chart for URL purification according to one embodiment of the present disclosure;

FIG. 2 illustrates a schematic diagram of an embodiment according to the URL purification in FIG. 1;

FIG. 3 illustrates a structural schematic diagram of an URL template in one embodiment of the present disclosure;

FIG. 4 illustrates a structural schematic diagram of a URL purification apparatus according to one embodiment of the present disclosure;

FIG. 5 schematically illustrates a block diagram of a server for executing the method according to the present disclosure; and

FIG. 6 schematically illustrates a memory cell for keeping or carrying a program code which can realize the method according to the present disclosure.

### DESCRIPTION OF THE EMBODIMENTS

Exemplary embodiments of the disclosure will be described in detail with reference to the accompanying figures hereinafter. Although the exemplary embodiments of the disclosure are illustrated in the accompanying figures, it should be understood that the disclosure may be embodied in many different forms and should not be construed as being limited to the embodiments set forth herein. Rather, these embodiments are provided so that this disclosure will be understood thoroughly and completely and will fully convey the scope of the disclosure to those skilled in the art.

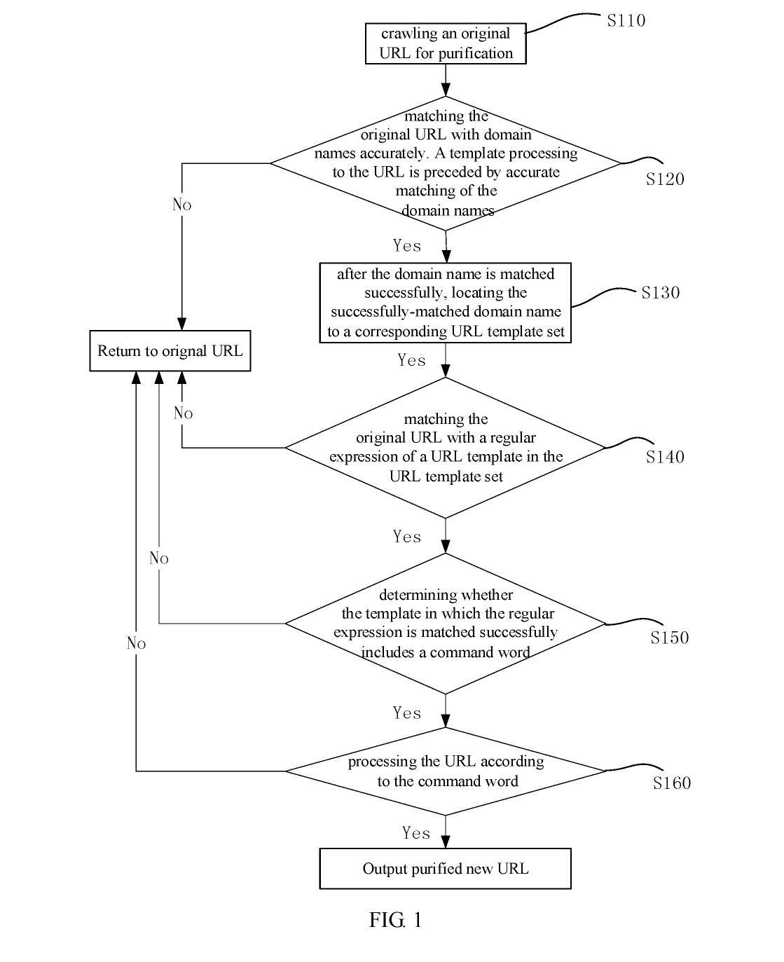

As illustrated in FIG. 1, a URL purification method, including the following steps:

step S110, crawling an original URL for purification.

step S120, matching the original URL with domain names accurately. A template processing to the URL is preceded by accurate matching of the domain names; the original URL to be processed is matched with domain names in a domain name set which is capable of being purified one by one. It is required to determine whether the matching is successful; if yes, execute step S130; if not, return to the original URL. One or more domain names are included in the domain name set.

step S130, after the domain name is matched successfully, locating the successfully-matched domain name to a corresponding URL template set, and fetching the URL template set which belongs to the domain name.

step S140, matching the original URL with URL templates in the URL template set in order, specifically, matching the original URL with a regular expression of a URL template in the URL template set; determining whether the matching is successful; if yes, execute step S150 for subsequent purification; if not, return to the original URL. One or more domain names are included in the domain name set.

step S150, determining whether the template in which the regular expression is matched successfully includes a command word; if yes, execute step S160; if not, return to the original URL.

step S160, processing the URL according to the command word; determining whether the processing is successful; if yes, output a purified new URL; if not, return to the original URL.

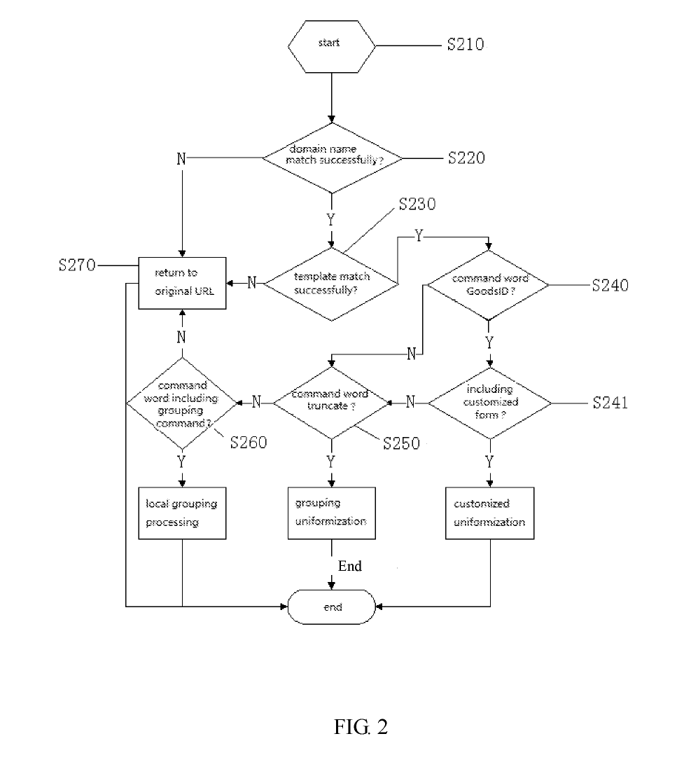

According to the above processing flow, the URL purification process, in particular purification of the URL according to the command word is described herein below in embodiments in combination with FIG. 2.

step S210, crawling the original URL for purification;

step S220, matching the original URL with the domain names accurately; determining whether the matching is successful; if yes, executing step S230; if not, executing step S270;

step S230, after the domain name is matched successfully, locating the successfully-matched domain name to a corresponding URL template set; fetching the URL template set which belongs to the domain name; matching the original URL with a regular expression of a URL template in the URL template set; determining whether the matching is successful; if yes, executing step S240 for subsequent purification; if not, executing step S270;

step S240, determining whether the template in which the regular expression is matched successfully includes a command word GoodsID; if yes, executing step S241; if not, executing step S250;

step S241, determining whether the template in which the command word GoodsID is included includes a URL customized standard form; if yes, extracting the GoodsID and return after generating a new URL according to the customized standard form; namely, end the processing after outputting a purified new URL; if not, executing step S250;

step S250, determining whether the command word includes truncate; if yes, extracting grouping matching parts in the successfully-matched regular expression and return after combining the grouping matching parts into a new URL; namely, end the processing after outputting a purified new URL; if not, executing step S260;

step S260, determining whether the command word includes certain grouping commands; if yes, returning after processing grouping strings and combining the grouping strings into a new URL; namely, ending the processing after outputting a purified new URL; if not, executing step S270;

step S270, returning the original URL (original URL data) and ending the processing.

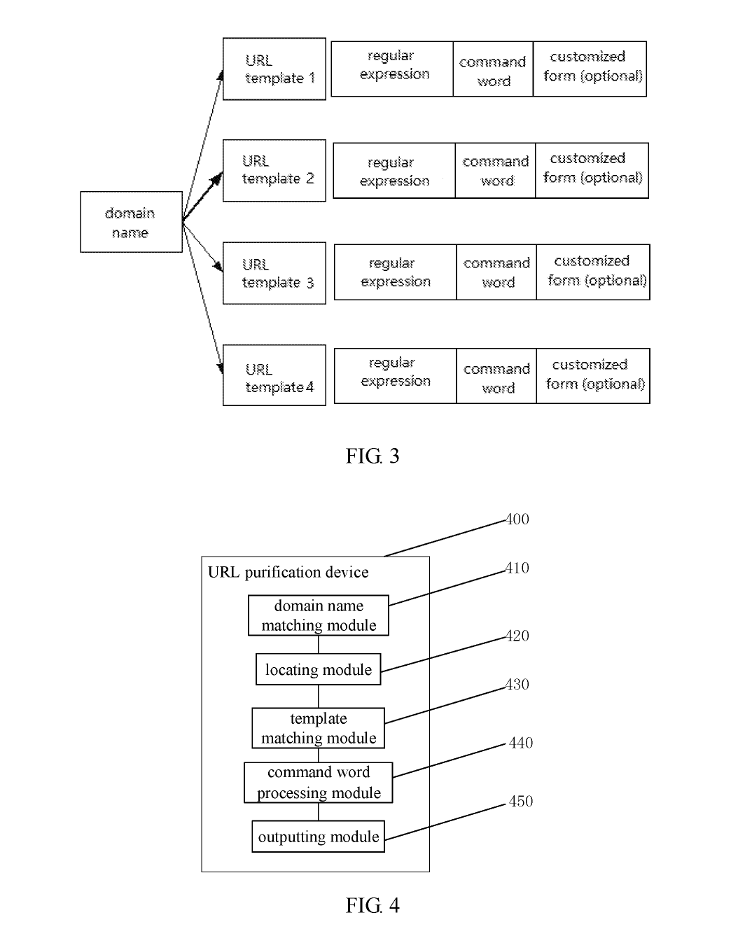

According to the above processing process, a URL temperature is of such a mechanism as illustrated in FIG. 3, and each URL template may consist of such three elements as domain name, regular expression and command word or such four elements as domain name, regular expression, command word and customized standard form. The URL templates are grouped based on domain names; the command word may include one command or a combination of more commands; and a plurality of command words are separated from each other by “.” (for example up_1. GoodsID_1).

Names and corresponding explanations of command words supported and applied in the URL purification of the present disclosure are as shown herein below in the table:

| Name | Explanations |
|---|---|
| GoodsID_n | Extract GoodsID information from the n^{th} group |
| truncate | Reserve group-matched information only; return truncated |
| | result |
| Low_n | Convert the n^{th} group to lowercase |
| up_n | Convert the n^{th} group to uppercase |

Application methods of the command words in the present disclosure are illustrated herein below in the embodiments:

### Embodiment One

command word GoodsID. Such command word is applicable to a website where URL forms are variable and the final form cannot be combined until a rule is concluded and key parts are found.

For example, some B2C (Business to Customer) websites are not so normative in links, more than one link may appear on websites simultaneously, for example: http://www.eggcoo.com/page_product_527393_0.html http://www.eggcoo.com/product.shtml?method=detailView&id=527393&cv=0

The above two different links appear in a golden egg shopping mall, but in fact they are linked to the same commodity.

Further for example, some time-honored big B2C websites may be revised time to time and have the same condition:

http://www.amazon.cn/gp/product/B0019DBU60?ver=gp&uid=476-6816060-6082564& pageletid=taiwan (from a list page)

http://www.amazon.cn/mn/detailApp/ref=sr_1_1?encoding=UTF8 &s=electronics&qid=1278389145&asin=B0019DBU60&sr=8-1 (from a search page)

http://www.amazon.cn/%CC%C0%C4%B7%D1%B7+%C0%F2%C2%EA+%B1%CA%BC%C7%B1%BE%D2%F4%CF%E4+DS-A07203%2C%CC%F4%D5%BD%D0%D4%BC%DB%B1%C8%BC%AB%CF%DE%21/dp/B0019DBU60 (from sitemap)

The above three different links appear on amazon.cn, but in fact they are linked to the same commodity.

The purification method for the above URLs is based on command word GoodsID and customized trunk extraction, and a returning rule shall be customized:

(1) Links for the golden egg shopping mall shall be written in the following rules:

{“www.eggcoo.com”, “̂/product.shtml\?.*id=(\d+).*$”, “GoodsID_1”, “/product.shtml\?.*id=% s”}

{“www.eggcoo.com”, “̂/page_product_(\d+)_(\d+).html”, “GoodsID_1”, “/product.shtml\?.*id=% s”}

In application of the above two rules, the links of the above-mentioned golden egg shopping mall return to

http://www.eggcoo.com/page_product_527393_0.html

(2) Links for amazon.cn shall be written in the following rules:

{“www.amazon.cn”, “̂/gp/product/([A-Za-z0-9]+)\?ver=gp.*$”, “up_1. GoodsID_1”, “/gp/product/% s”}

{“www.amazon.cn”, “̂/mn/detailApp/ref-.*\?.*asin=([A-Za-z0-9]+).*$”, “up_1. GoodsID_1”, “/gp/product/% s”}

{“www.amazon.cn”, “̂/(.*)/dp/([A-Za-z0-9]+).*$”, “up_2. GoodsID_2”, “/gp/product/% s”}

In application of the above three rules, the links of amazon.cn returns to

http://www.amazon.cn/gp/product/B0019DBU60

### Embodiment Two

command word truncate. Such command word is applicable to URLs followed by additional information. At present, many websites add some additional parameters after URL for source marking or statistics. Such actions are quite common and are quite easy to process, for example:

http://www.vancl.com/Product_0006984/BaiHeHuaLianYiQun%20HongSeYinHua.html?Source=eqf&SourceSunInfo=96845|yqftid_12783880711284196186

Purification method of such URL is to employ the command word truncate. Grouping (adding a pair of brackets) is set for all data which require reserving, and only grouping result is returned, such as the following rule:

{“www.vancl.com”, “̂(/Product [0-9]+/[\w]+\.html).*.*$”, “truncate”, null}

In the application of such rule, the above-mentioned link returns to:

http://www.vancl.com/Product_0006984/BaiHeHuaLianYiQun%20HongSeYinHua.html

### Embodiment Three

command word is a grouping command. Such command word is applicable to websites whose URLs are case-insensitive. The URL is case-insensitive for some websites, while URLs in an upper-case form and a lower-case form correspond to different links for a crawler respectively. In such situations, the grouping command can be employed to uniformly transform a certain grouping from an upper-case to a lower-case or from a lower-case to an upper-case.

For example, the URL of dangdang.com is:

http://product.dangdang.com/product.aspx?product_id=22799821

http://product.dangdang.com/Product.aspx?product_id=22799821

The above two different URLs are linked to the same commodity.

For the purification of such URLs, command word up or low can be employed to control the upper-case or the lower-case of a matched grouping part, wherein up_n represents that the n^{th} group is transformed into upper-case, and low_n represents that the n^{th} group is transformed into lower-case, such as the following rule:

{“product.dangdang.com”, “(?i)̂/(P)roduct.aspx?product_id=\d+.*$”, “low_1”, null}

Such a rule indicates to return the first matched group in a lower-case form. Similarly, when “low_1” is replaced by “up_1”, it is represented to return the first matched group in the upper-case form.

It can be concluded from the embodiments of the present disclosure that purifying a URL can improve capacity of the crawler of a search engine to crawl valid webpages, and therefore various resources are saved.

Another embodiment of the present disclosure is as illustrated in FIG. 4. Detailed description of the principle is left out herein for completely the same content as described above. A URL purification apparatus 400, including the following modules of:

a domain name matching module 410, configured to match an original URL with a domain name in a domain name set which is capable of being purified, wherein one or more domain names are included in the domain name set;

a locating module 420, configured to locate a successfully-matched domain name to a corresponding URL template set, wherein one or more URL templates are included in the URL template set;

a template matching module 430, configured to match the original URL with a regular expression of a URL template in the URL template set, wherein the URL template includes domain name, regular expression, command word and customized form (optional);

a command word processing module 440, configured to determine whether the template in which the regular expression is matched successfully includes a command word, if yes, process the URL according to the command word and turn to an outputting module to output a purified new URL, if not, return to the original URL. Specifically, when the command word processing module 440 determines that the command word included in the template in which the regular expression is matched successfully is GoodsID, and the template in which the regular expression is matched successfully includes a customized form, the URL is processed according to the command word, including extracting the GoodsID and generating a new URL according to a standard of the customized form; when the command word processing module 440 determines that the command word included in the template in which the regular expression is matched successfully is truncate, grouping matching parts in the successfully-matched regular expression are extracted and the grouping matching parts are combined into a new URL; when the command word processing module 440 determines that the command word included in the template in which the regular expression matches successfully is grouping command, grouping strings are processed and the grouping strings are combined into a new URL; the grouping command includes a low_n command and an up_n command, wherein the low_n command represents that the n^{th} group is transformed into a lower-case form, and the up_n command represents that the n^{th} group is transformed into an upper-case form; when the command word processing module 440 determines that command word included in the template in which the regular expression is matched successfully is GoodsID, but the template in which the regular expression is matched successfully does not include a customized form, it is required to further determine whether the template in which the regular expression is matched successfully includes a command word truncate, if yes, grouping matching parts in the successfully-matched regular expression are extracted, and the grouping matching parts are combined into new URL; otherwise, it is required to further determine whether the template in which the regular expression is matched successfully includes a command word grouping command, if yes, grouping strings are processed and combined into new URL; otherwise, it is required to return the original URL;

an outputting module 450, configured to output a purified new URL.

Each of devices according to the embodiments of the disclosure can be implemented by hardware, or implemented by software modules operating on one or more processors, or implemented by the combination thereof. A person skilled in the art should understand that, in practice, a microprocessor or a digital signal processor (DSP) may be used to realize some or all of the functions of some or all of the modules in the apparatus of the client or server according to the embodiments of the disclosure. The disclosure may further be implemented as device program (for example, computer program and computer program product) for executing some or all of the methods as described herein. Such program for implementing the disclosure may be stored in the computer readable medium, or have a form of one or more signals. Such a signal may be downloaded from the internet websites, or be provided in carrier, or be provided in other manners.

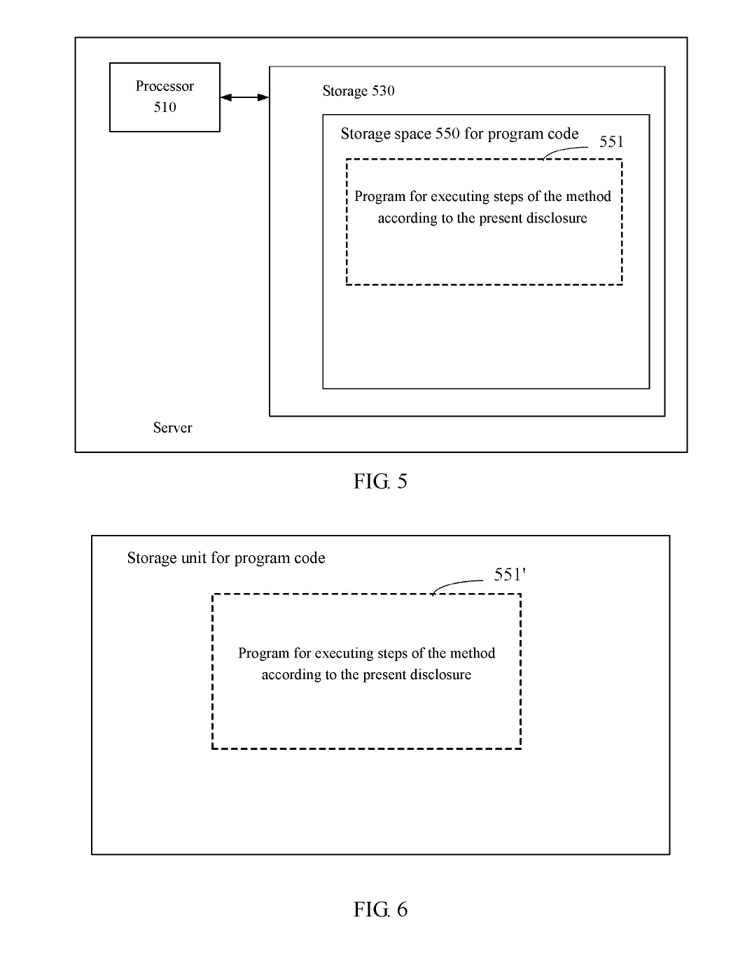

For example, FIG. 5 illustrates a block diagram of a server for executing the method according the disclosure, such as a search engine server. Traditionally, the server includes a processor 510 and a computer program product or a computer readable medium in form of a memory 530. The memory 530 could be electronic memories such as flash memory, EEPROM (Electrically Erasable Programmable Read-Only Memory), EPROM, hard disk or ROM. The memory 530 has a memory space 550 for executing program codes 551 of any steps in the above methods. For example, the memory space 550 for program codes may include respective program codes 551 for implementing the respective steps in the method as mentioned above. These program codes may be read from and/or be written into one or more computer program products. These computer program products include program code carriers such as hard disk, compact disk (CD), memory card or floppy disk. These computer program products are usually the portable or stable memory cells as shown in reference FIG. 6. The memory cells may be provided with memory sections, memory spaces, etc., similar to the memory 550 of the server as shown in FIG. 5. The program codes may be compressed for example in an appropriate form. Usually, the memory cell includes computer readable codes 551′ which can be read for example by processors 510. When these codes are operated on the server, the server may execute respective steps in the method as described above.

The “an embodiment”, “embodiments” or “one or more embodiments” mentioned in the disclosure means that the specific features, structures or performances described in combination with the embodiment(s) would be included in at least one embodiment of the disclosure. Moreover, it should be noted that, the wording “in an embodiment” herein may not necessarily refer to the same embodiment.

Many details are discussed in the specification provided herein. However, it should be understood that the embodiments of the disclosure can be implemented without these specific details. In some examples, the well-known methods, structures and technologies are not shown in detail so as to avoid an unclear understanding of the description.

It should be noted that the above-described embodiments are intended to illustrate but not to limit the disclosure, and alternative embodiments can be devised by the person skilled in the art without departing from the scope of claims as appended. In the claims, any reference symbols between brackets form no limit of the claims. The wording “include” does not exclude the presence of elements or steps not listed in a claim. The wording “a” or “an” in front of an element does not exclude the presence of a plurality of such elements. The disclosure may be realized by means of hardware comprising a number of different components and by means of a suitably programmed terminal device. In the unit claim listing a plurality of devices, some of these devices may be embodied in the same hardware. The wordings “first”, “second”, and “third”, etc. do not denote any order. These wordings can be interpreted as a name.

Also, it should be noticed that the language used in the present specification is chosen for the purpose of readability and teaching, rather than explaining or defining the subject matter of the disclosure. Therefore, it is obvious for an ordinary skilled person in the art that modifications and variations could be made without departing from the scope and spirit of the claims as appended. For the scope of the disclosure, the publication of the inventive disclosure is illustrative rather than restrictive, and the scope of the disclosure is defined by the appended claims.

1. A uniform resource locator (URL) purification method comprising:
matching an original URL with a domain name in a domain name set which is capable of being purified;
locating a successfully-matched domain name to a corresponding URL template set;
matching the original URL with a regular expression of a URL template in the URL template set;
determining whether the template in which the regular expression is matched successfully includes a command word; if yes, processing the URL according to the command word, if not, returning to the original URL; and
outputting a purified new URL.

2. The URL purification method according to claim 1, wherein,
when it is determined that the command word included in the template in which the regular expression is matched successfully is GoodsID, and the template in which the regular expression is matched successfully includes a customized form, processing the URL according to the command word, including extracting the GoodsID and generating a new URL according to a standard of the customized form.

3. The URL purification method according to claim 1, wherein:
when it is determined that the command word included in the template in which the regular expression is matched successfully is truncate, extracting grouping matching parts in the successfully-matched regular expression and combining the grouping matching parts into a new URL.

4. The URL purification method according to claim 1, wherein:
when it is determined that the command word included in the template in which the regular expression matches successfully is grouping command, processing grouping strings and combining the grouping strings into a new URL.

5. The URL purification method according to claim 4, wherein:
when the grouping command includes a low_n command, it is represented that the n^{th} group is transformed into a lower-case form; when the grouping command includes an up_n command, it is represented that the n^{th} group is transformed into an upper-case form.

6. The URL purification method according to claim 1, wherein:
when it is determined that the command word included in the template in which the regular expression is matched successfully is GoodsID, but the template in which the regular expression is matched successfully does not include a customized form, further determining whether the template in which the regular expression is matched successfully includes a command word truncate, if yes, extracting grouping matching parts in the successfully-matched regular expression, combining the grouping matching parts into a new URL; otherwise, further determining whether the template in which the regular expression is matched successfully includes a command word grouping command, if yes, processing grouping strings and combining the grouping strings into a new URL; otherwise, returning the original URL.

7. The URL purification method according to claim 1, wherein,
the domain name set comprises one or more domain names, the URL template set comprises one or more URL templates.

8. The URL purification method according to claim 1, wherein,
the URL template comprises a domain name, a regular expression and a command word.

9. The URL purification method according to claim 8, wherein,
the URL template further comprises a customized form.

10. (canceled)

11. A non-transitory computer readable medium having computer programs stored thereon that, when executed by one or more processors of a server, cause the server to perform;
matching an original URL with a domain name in a domain name set which is capable of being purified;
locating a successfully-matched domain name to a corresponding URL template set;
matching the original URL with a regular expression of a URL template in the URL template set;
determining whether the template in which the regular expression is matched successfully includes a command word: if yes, processing the URL according to the command word, if not, returning to the original URL; and
outputting a purified new URL.

12. A server for uniform resource locator (URL) purification comprising:
a memory having instructions stored thereon;
a processor configured to execute the instructions to perform operations for URL purification, comprising:
a domain name matching module, configured to matching an original URL with a domain name in a domain name set which is capable of being purified;
a locating module, configured to locate locating a successfully-matched domain name to a corresponding URL template set;
a template matching module, configured to matching the original URL with a regular expression of a URL template in the URL template set;
a command word processing module, configured to determine determining whether the template in which the regular expression is matched successfully includes a command word; if yes, processing the URL according to the command word, if not, returning to the original URL; and
an outputting module, configured to outputting a purified new URL.

13. The server according to claim 12, wherein,
when it is determined that the command word included in the template in which the regular expression is matched successfully is GoodsID, and the template in which the regular expression is matched successfully includes a customized form, processing the URL according to the command word, including extracting the GoodsID and generating a new URL according to a standard of the customized form.

14. The server according to claim 12, wherein:
when it is determined that the command word included in the template in which the regular expression is matched successfully is truncate, extracting grouping matching parts in the successfully-matched regular expression and combining the grouping matching parts into a new URL.

15. The server according to claim 12, wherein:
when it is determined that the command word included in the template in which the regular expression matches successfully is grouping command, processing grouping strings and combining the grouping strings into a new URL.

16. The server according to claim 15, wherein:
when the grouping command comprises a low_n command, it is represented that the n^{th} group is transformed into a lower-case form; when the grouping command comprises an up_n command, it is represented that the n^{th} group is transformed into an upper-case form.

17. The server according to claim 12, wherein:
when it is determined that the command word included in the template in which the regular expression is matched successfully is GoodsID, but the template in which the regular expression is matched successfully does not include a customized form, further determining whether the template in which the regular expression is matched successfully includes a command word truncate, if yes, extracting grouping matching parts in the successfully-matched regular expression, combining the grouping matching parts into a new URL; otherwise, further determining whether the template in which the regular expression is matched successfully includes a command word grouping command, if yes, processing grouping strings and combining the grouping strings into a new URL; otherwise, returning the original URL.

18. The server according to claim 12, wherein,
the domain name set comprises one or more domain names, the URL template set comprises one or more URL templates.

19. The server according to claim 12, wherein,
the URL template comprises a domain name, a regular expression and a command word.

20. The server according to claim 19, wherein,
the URL template further comprises a customized form.
